(19) United States
(12) Patent Application Publication
(10) Pub. No.: US 2008/0257633 A1
(43) Pub. Date: Oct. 23, 2008

(54) Hydro-Mechanically Coupled Electric Power Steering System

(75) Inventor: Edward H. Phililips, Troy, MI (US)

Correspondence Address: CARLSON, GASKEY & OLDS, P.C., 400 WEST MAPLE ROAD, SUITE 350, BIRMINGHAM, MI, 48009, US

(73) Assignees: ARVINMERITOR TECHNOLOGY, LLC., Troy, MI (US); TECHCO CORP., Southfield, MI (US)

(21) Appl. No.: 11/573,874

(22) PCT Filed: Aug. 16, 2005
(86) PCT No.: PCT/US2005/029056

§ 371 Date: Feb. 5, 2008

Related U.S. Application Data
(60) Provisional application No. 60/602,027, filed on Aug. 16, 2004.
(60) Provisional application No. 60/672,387, filed on Apr. 18, 2005.

(51) Int. Cl. B62D 5/065; F15B 13/04; F16K 31/06

(52) U.S. Cl. 180/417; 251/129.15

(57) ABSTRACT

A power steering system provides improved steering feel whenever negligible power assist is required is required such as during on-center operation or at very high vehicular speeds. The power steering system includes fluid lines used for directly coupling a motor driven pump to a power cylinder. The fluid lines are coupled to a system reservoir or to one another whenever a primary control signal indicative of steering wheel torque has a value below a selected threshold value thereby substantially decoupling the power cylinder from the pump.

This application claims priority to U.S. Provisional Applications Serial Nos. 60/602,027, filed Aug. 16, 2004 and 60/672,387, filed Apr. 18, 2005.

### BACKGROUND OF THE INVENTION

The present invention relates generally to power steering systems for vehicles, and more particularly to hydro-mechanically coupled electrically powered steering systems.

Currently it is anticipated that an overwhelming majority of vehicular power steering systems will be electrically powered in the future. Most common will be electric power steering systems (hereinafter “EPS systems”) wherein motors deliver torque as a function of current applied to them by a controller. One example is described in U.S. Pat. No. 6,152,254, entitled “Feedback and Servo Control for Electric Power Steering System with Hydraulic Transmission,” issued Nov. 28, 2000, which is hereby incorporated by reference in its entirety. In that EPS system differential pressure is directly delivered to a double-acting power cylinder from a motor driven reversible fluid pump.

The EPS system described in the '254 patent may at times reflect motor inertia from the system back to the vehicle's steering wheel whenever negligible power assist is required, such as during on-center operation or at very high vehicular speeds. This may be made worse because the motor inertia is compliantly coupled to the steering wheel via a compliant member such as a torsion bar.

Additionally, new steering applications have been presented wherein on-center pressure offsets will be required for the purpose of negating nominally steady road crown and/or side wind induced steering loads. This is a problem because the hydraulically coupled EPS system described in the '254 patent includes a two-position, three-way (shuttle) valve utilized for the purpose of coupling the lower pressure ports of the pump and power cylinder to system reservoir pressure. It has been found that provision of even the small amount of fluid required for displacing the two position, three-way shuttle valve can result in an undesirable impulse to the host vehicle's steering wheel whenever there is an on-center pressure offset. This is because reversal of differential pressure polarity then occurs within at least a transition region between on-center and linear operation. In greater detail, the pump must speed up to displace the two position, three-way shuttle valve and then comes to an abrupt reduction in speed when the two position, three-way shuttle valve is seated at its new location. This results in a fluid pressure spike that is transmitted to the steering wheel via the power cylinder, rack-and-pinion interface, and steering shaft.

### SUMMARY OF THE INVENTION

A hydro-mechanically coupled power steering system according to the present invention, provides a significant improvement to the EPS system with hydraulic transmission described in the '254 patent. The EPS system with hydraulic transmission includes first and second fluid lines that directly couple a motor driven pump to a power cylinder included in a steering gear. The system improves steering feel whenever negligible power assist is required such as during on-center operation or at very high vehicular speeds by substantially decoupling the power cylinder from the pump.

In exemplary embodiments, the first and second fluid lines are coupled either to a system reservoir or to one another whenever a primary control signal indicative of steering wheel torque has a value below a selected threshold value. This substantially decouples the power cylinder from the pump. Decoupling the power cylinder from the pump serves to improve steering feel whenever negligible power assist is required because it eliminates the reflected motor inertia from the system. The power cylinder may subsequently be progressively re-coupled to the fluid pump as the steering wheel torque increases. Generally, the threshold value is selected to be an increasing function of vehicular speed and may even be increased without bound at very high vehicular speeds.

In another aspect of the present invention, a solenoid-controlled valve apparatus (or valve assembly) is presented for accommodating reversals of differential pressure polarity by being electrically driven rather than being hydraulically driven (e.g., without utilizing any pumped fluid). In addition, improved fresh fluid replenishment is provided by a pair of check valves utilized in conjunction with the solenoid-controlled valve apparatus. Further, the solenoid-controlled valve apparatus and check valves in this embodiment reduce the number of parts by replacing a solenoid-controlled two-position relief valve, suction line, (power cylinder mounted) check valves, and the two position, three-way shuttle valve.

In addition to issuing a solenoid-controlling signal to either of the first and second solenoids, the system controller issues motor-controlling signals to the motor utilized for driving the pump. The motor controlling signals are issued in dependence upon an applied torque signal indicative of steering torque applied to the host vehicle's steering wheel as generated by at least one of redundant applied torque sensors as well as feedback signals indicative of fluid pressure present in the first and second fluid lines provided by respective first and second pressure transducers. Thus, the pump is caused to deliver appropriately pressurized fluid to one of first and second ports of the power cylinder while the other one of the first and second ports is fluidly coupled to the system reservoir. In the unlikely event of an unexpected system fault, both the motor-controlling and solenoid-controlling signals are faulted to ground potential with the results that the pump stops and the improved hydraulically coupled EPS system immediately goes into a fail-safe mode wherein both of the first and second fluid lines are fluidly coupled to the system reservoir as explained above. Thus, the hydraulically coupled EPS system is controlled in the general manner taught in the '254 patent.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 is a schematic view representative of an example hydro-mechanically coupled power steering system according to the present invention.

FIG. 2 is a schematic view representative of a second embodiment of an example hydro-mechanically coupled power steering system of the present invention.

FIG. 3 is a schematic plan view representative of a third embodiment of an example hydro-mechanically coupled power steering system of the present invention;

FIGS. 4A, 4B and 4C are sectional views of the solenoid-controlled two-way valves of FIG. 3 in three different positions; and

FIG. 5 is a plot depicting operational steering characteristics enabled by the hydraulically coupled power steering system of the present invention.

### DETAILED DESCRIPTION OF THE PREFERRED EMBODIMENT

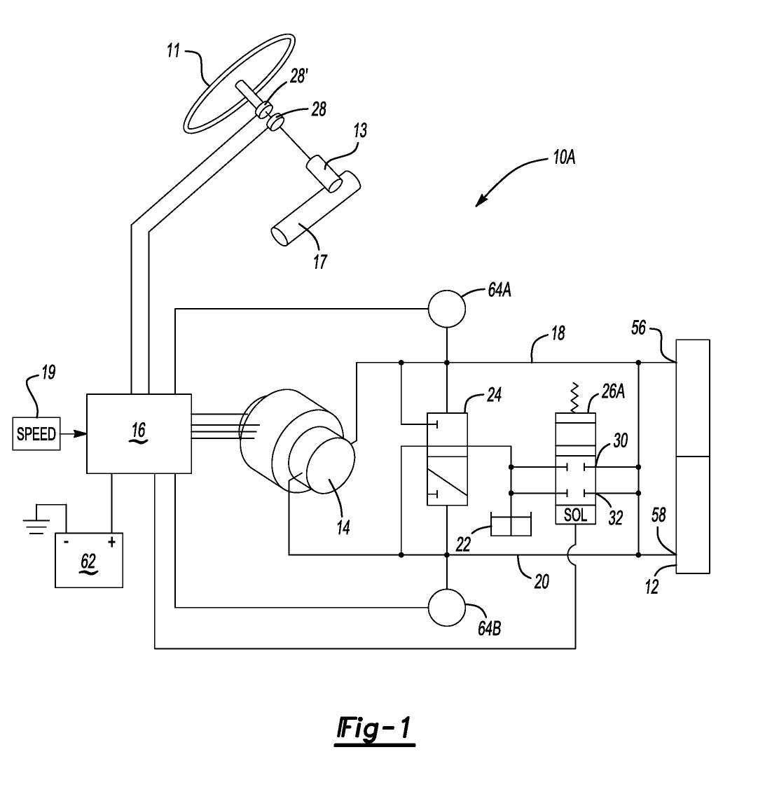

One example of a hydro-mechanically coupled power steering system 10A is shown schematically in FIG. 1. FIG. 1 depicts most of the elements of the hydro-mechanically coupled power steering system of the '254 patent. A steering wheel 11 is connected to the steerable wheels (not shown) by a suitable steering gear 13 engaged (directly or indirectly) with a gear rack 17. A torque sensor 28 is connected to the steering wheel 11 and generates an electrical or electronic signal representative of the magnitude and direction of a steering torque applied to the steering wheel 11. A secondary torque sensor 28′ provides a redundant torque signal utilized in a fail-safe function for the power steering system 10A. The application of an applied steering torque to the steering wheel 11, as sensed by the torque sensor 28, results in the application by the power steering system 10A of an assisted steering force to the steerable wheels.

The power steering system 10A includes a power cylinder 12 connected to the gear rack 17 (connection not shown) and arranged to apply an assistive force to longitudinal movement of the gear rack 17. The power cylinder 12 has a first (or “left”) port 56 and a second (or “right”) port 58 and may be a double-acting power cylinder 12. Upon the supply of a pressurized fluid to one of the first port 56 and the second port 58, the power cylinder 12 assists longitudinal movement of the gear rack 17 in the associated direction by applying an assistive force to it. Of course, a manual, mechanical steering force is concurrently supplied to the steerable wheels through the steering gear 13 and rack 17 as well. The total steering force applied to the steerable wheels is the sum of the manual steering force and the powered assist provided by the power cylinder 12.

Differential pressure is directly delivered to the power cylinder 12 from a pump 14 controlled by a controller 16. The controller 16 may include a microprocessor, memory and suitable computer programming to control the functions as described herein or may be a hardwired control circuit. A vehicle sensor, which in this example is a vehicle speed sensor 19, sends a signal indicative of current vehicle speed to the controller 16. The pump 14 may be motor driven and reversible. In addition, the lower pressure one of the fluid line 18 or the fluid line 20 is fluidly coupled to a system reservoir 22 via a three-way shuttle valve 24. This serves to keep system pressure at its lowest possible value at all times.

The first and second pressure transducers 64a and 64b issue respective first and second pressure signals representative of instant pressure values present in the fluid lines 18 and 20. As described in the '254 patent, the first and second pressure signals are then used by the controller 16 in an inner control loop for achieving accurate and stable selected differential pressure values in the power cylinder 12 in dependence upon instant torque signals from the torque sensor 28, vehicle speed and any other desired parameter. The secondary torque sensor 28′ provides a redundant torque signal utilized in a fail-safe function for the power steering system 10A.

Fluid lines 18 and 20 are fluidly coupled to the system reservoir 22 by a valve 26a as controlled by the controller 16 when a primary control signal indicative of steering wheel torque issued from torque sensor 28 has a value below a selected threshold value. The valve 26a may be a proportionally-controlled spring-loaded compound two-way valve 26a. The fluid lines 18 and 20 are progressively de-coupled from the system reservoir 22 as the primary control signal indicative of steering wheel torque increases. In one example, the threshold value is selected to be an increasing function of vehicular speed and may in fact be increased without bound at relatively high vehicular speeds. The resulting decoupling of the power cylinder 12 from the pump 14 serves to improve on-center steering feel whenever negligible power assist is required, such as during on-center operation or at very high vehicular speeds. This is because the decoupling enables elimination of the reflected motor inertia from the system.

Optionally, the fluid lines 18 and 20 may be coupled to the reservoir based upon the torque dropping below a first threshold and may be decoupled from the system reservoir 22 based upon the torque exceeding a second threshold, equal to or different from the first threshold. The fluid lines 18 and 20 may be progressively coupled to the system reservoir 22 and progressively decoupled from the system reservoir 22 as a function of vehicle speed and/or steering wheel torque.

In the illustrated example, inclusion of the valve 26a permits elimination of a relief valve, suction line, and a pair of check valves from the EPS system with hydraulic transmission (as described in the '254 patent). The relief valve was used as a fail-safe device to couple both fluid lines 18 and 20 to the system reservoir 22 should a system failure occur. The spring-loaded feature of the valve 26a biases the valve 26a to an open position as an operational fail-safe feature. In the open position, the fluid lines 18 and 20 are fluidly connected to the system reservoir 22 in the event of any system failure. Thus, the valve 26a performs the function of the relief valve. Since the fluid lines 18 and 20 are independently coupled to the system reservoir 22 by the valve 26a via ports 30 and 32, the valve 26a serves to introduce fresh reservoir fluid under steering recovery situations as well.

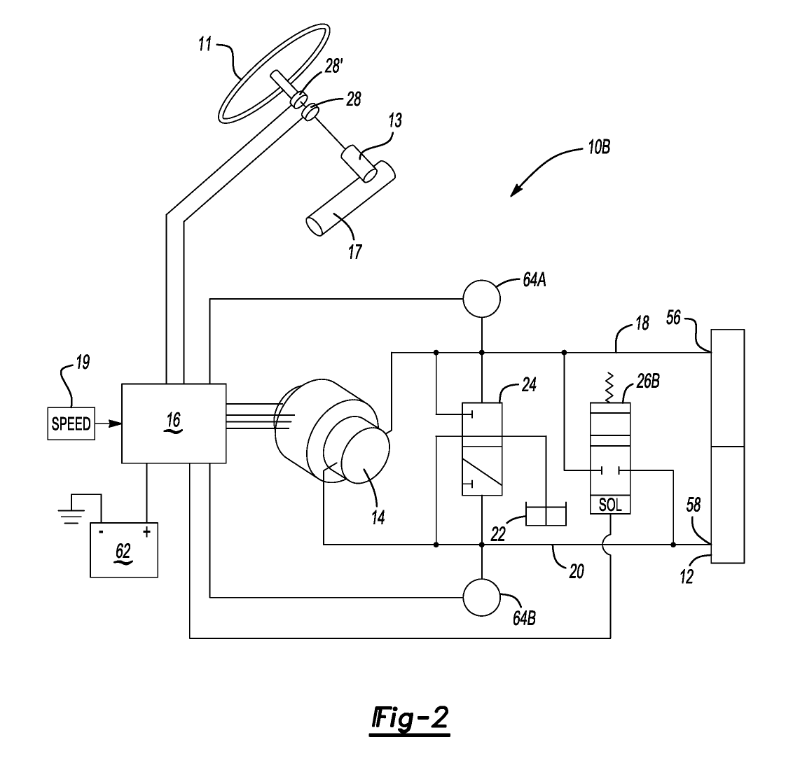

A second embodiment of a hydro-mechanically coupled power steering system 10B is shown in FIG. 2. In the power steering system 10B, the fluid lines 18 and 20 are fluidly coupled to one another by a valve 26B, which may be a proportionally-controlled spring-loaded two-way valve. To the extent not otherwise described or shown, the second embodiment of the power steering system 10B and its operation is the same as that of the first embodiment in FIG. 1. The valve 26B serves to fluidly couple the fluid lines 18 and 20 one to another whenever the primary control signal indicative of steering wheel torque issued from torque sensor 28 has a value below a selected threshold value. The fluid lines 18 and 20 are then progressively de-coupled from one another as the primary control signal indicative of steering wheel torque increases in the manner described above.

Optionally, the fluid lines 18 and 20 may be coupled to one another based upon the torque dropping below a first threshold and may be decoupled from one another based upon the torque exceeding a second threshold, equal to or different from the first threshold. The fluid lines 18 and 20 may be progressively coupled to one another and progressively decoupled from one another as a function of vehicle speed and/or steering wheel torque.

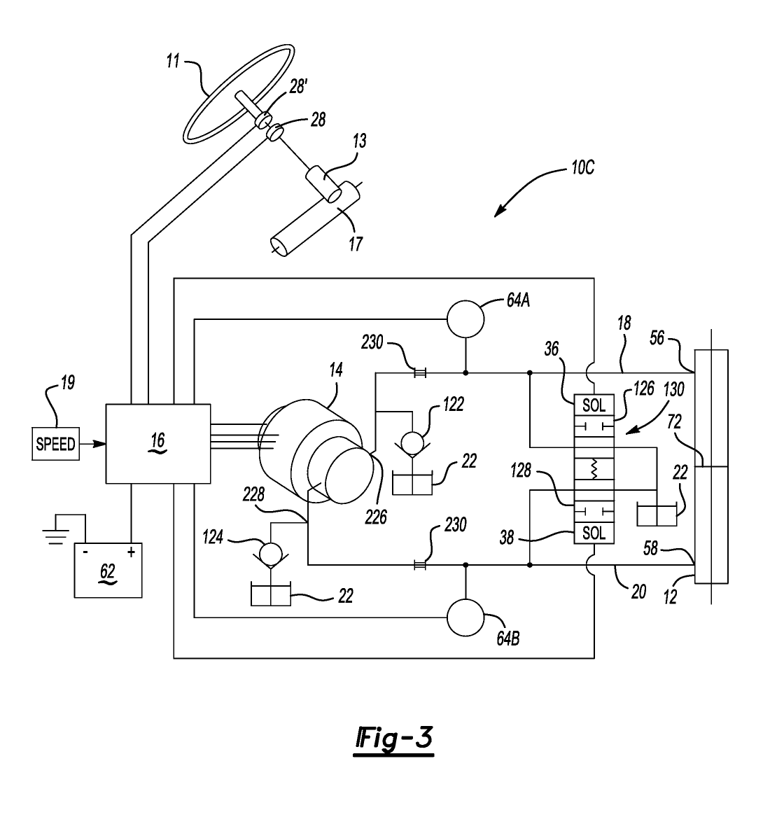

A power steering system 10C according to a third embodiment is shown in FIG. 3. To the extent not otherwise described or shown, the power steering system 10C and its components operate similarly to those in FIGS. 1-2. In this embodiment, the fluid line 18 or the fluid line 20 instantly conveying the lower-pressure fluid is fluidly coupled to the system reservoir 22 via a respective one of back-to-back solenoid-controlled two-way valves 126 and 128 included in a solenoid-controlled valve apparatus 130 (or “valve assembly”). This serves to keep system pressure at its lowest possible value at all times.

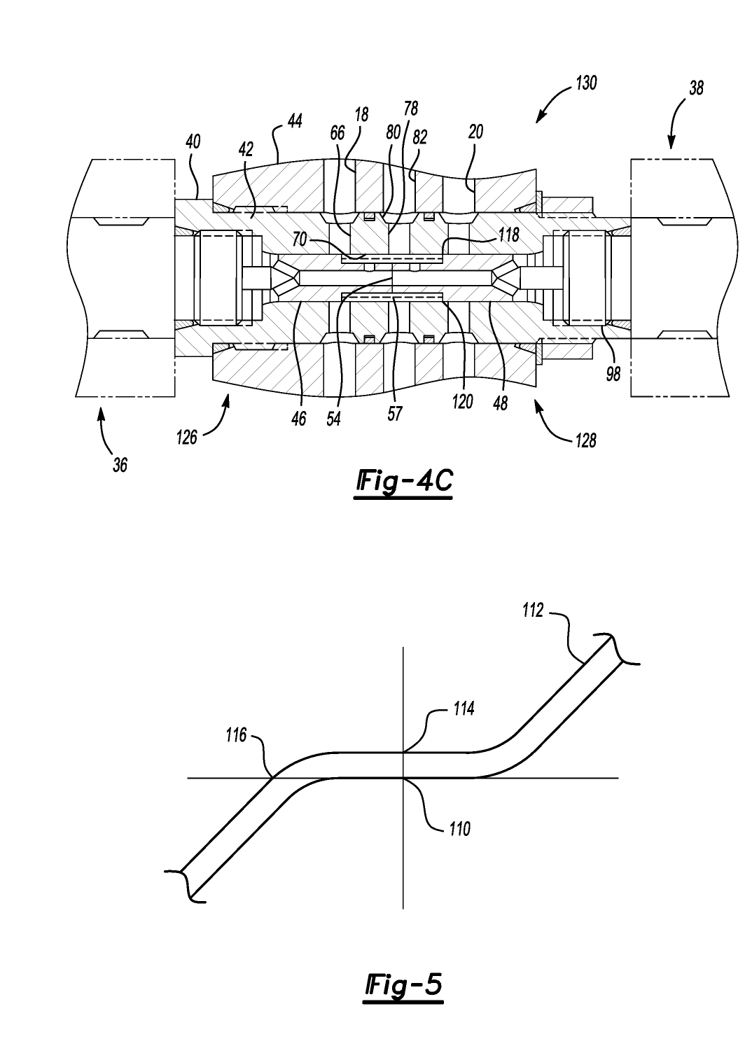

The improvement comes about because it has been found that provision of even the small amount of fluid required for displacing the two position, three-way shuttle valve 24 (FIGS. 1-2) can result in an undesirable impulse to the host vehicle's steering wheel 11 whenever the EPS system with hydraulic transmission is operated with a substantial on-center pressure offset as described in detail below with reference to FIG. 5. This is because reversal of differential pressure polarity can then occur within at least a transition region between on-center and linear operation. In greater detail, the pump 14 in FIGS. 1-2 must speed up in order to displace the valve 24 and then comes to an abrupt reduction in speed when the valve 24 is seated at its new location. This results in a fluid pressure spike being transmitted to the steering wheel 11 via the power cylinder 12, rack-and-pinion interface, and steering shaft. By way of contrast, the back-to-back solenoid-controlled two-way valves 126 and 128 utilized in the solenoid-controlled valve apparatus 130 are switched via actuation of respective first and second solenoids 36 and 38, and therefore are switched without similar fluid consumption.

As further explained in the '254 patent, a relief valve was used as a fail-safe device to simultaneously couple fluid lines and to the system reservoir 22 should a system failure occur. But herein, as will be described in greater detail below, this task is more easily accomplished by simply de-energizing both of the first and second solenoids 36 and 38. Thus, utilization of the solenoid-controlled valve apparatus 130 results in elimination of the relief valve, two-position, three-way valve, a suction line, and a (power cylinder mounted) pair of check valves.

Also, the solenoid-controlled valve apparatus 130 provides the decoupling function as described with respect to the embodiments in FIGS. 1-2, whenever negligible power assist is required such as during on-center operation or at very high vehicular speeds by substantially decoupling the power cylinder from the pump. The solenoid-controlled valve apparatus 130 serves to fluidly couple the fluid lines 18 and 20 one to another and to the system reservoir 22 whenever the primary control signal indicative of steering wheel torque issued from torque sensor 28 has a value below a selected threshold value. The fluid lines 18 and 20 are then progressively de-coupled from one another and from the system reservoir 22 as the primary control signal indicative of steering wheel torque increases in the manner described above. Optionally, as also described above, the fluid lines 18 and 20 may be coupled to one another and to the system reservoir 22 based upon the torque dropping below a first threshold and may be decoupled from one another and from the system reservoir 22 based upon the torque exceeding a second threshold, equal to or different from the first threshold. The fluid lines 18 and 20 may be progressively coupled to one another and progressively decoupled from one another as a function of vehicle speed and/or steering wheel torque.

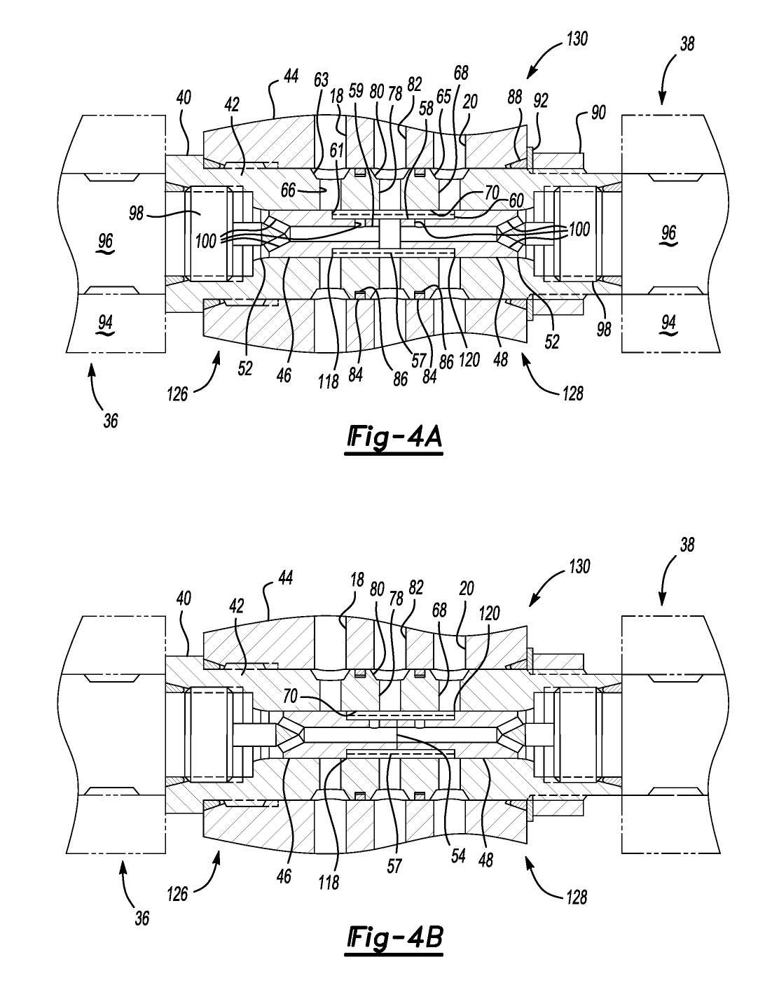

As depicted in FIGS. 4A, 4B and 4C, the solenoid-controlled valve apparatus 130 may be assembled within a valve body 40 formed such that it can be positioned and retained in a known manner within a straight thread “O” ring boss 42 formed in a manifold block 44. In any case, the back-to-back solenoid-controlled two-way valves 126 and 128 in solenoid-controlled valve apparatus 130 respectively include first and second valve spools 46 and 48 disposed within a common valve bore 50 formed in a valve body 40. Retaining rings 52 are provided for retaining the first and second valve spools 46 and 48 during handling prior to installing the first and second solenoids 36 and 38, but in normal use the first and second valve spools 46 and 48 abut one another at contact node 54 in the manner shown in FIGS. 4B and 4C.

The solenoid-controlled valve apparatus 130 also includes a compression spring 57 located by cylindrical bosses 59 and against shoulders 61 of the first and second valve spools 46 and 48. The above noted failsafe function is implemented by stopping the pump 14 and de-energizing both of the first and second solenoids 36 and 38 whereby the compression spring 57 urges both of the first and second valve spools 46 and 48 toward retracted positions as shown in FIG. 4A. Then fluid can freely pass between the first fluid line 18 and the second fluid line 20 via first and second circumferential grooves 63 and 65, first and second valve body ports 66 and 68, and annular passage 70 formed in and within the valve body 40. This enables emergency manual steering wherein fluid displaced by one side of the piston 72 of the power cylinder 12 is able to freely flow to the other via first and second ports 56 and 58 of the power cylinder 12, portions of the first fluid line 18 and the second fluid line 20 included within the manifold block 44, and the solenoid-controlled valve apparatus 130. This position also provides the function described above of decoupling the pump 14 and power cylinder 12 whenever negligible power assist is required such as during on-center operation or at very high vehicular speeds, since the fluid lines 18 and 20 are coupled together and to the system reservoir 22.

During normal operation of the power steering system 10C, one of the first or second solenoids 36 or 38 is energized as depicted in either of FIGS. 4B and 4C. This fully compresses the compression spring 57 as the first and second valve spools 46 and 48 are driven into contact with one another at the contact node 54. Then the first and second valve spools 46 and 48 are driven toward the retracted position of the other of the first and second solenoids 36 and 38. Preferably, the first and second solenoids 36 and 38 include internal compliant stops (not shown) in order to cushion the end stopping point. In any case, when the first solenoid 36 is energized as shown in FIG. 4B, the first and second valve spools 46 and 48 are driven toward the retracted position of the second solenoid 38 whereby the second valve body ports 68 are fluidly connected to the annular passage 70 and thus to valve body relief ports 78, relief circumferential groove 80, and reservoir fluid line 82, whereby the second fluid line 20 is fluidly coupled to the system reservoir 22. On the other hand, when the second solenoid 38 is energized as shown in FIG. 4C, the conjoined first and second valve spools 46 and 48 are driven toward the retracted position of the first solenoid 36 whereby the first valve body ports 66 are fluidly connected to the annular passage 70 and thus to valve body relief ports 78, relief circumferential groove 80, and reservoir fluid line 82, whereby the first fluid line 18 is fluidly coupled to the system reservoir 22.

It is of course necessary to fluidly isolate the relief circumferential groove 80 from the first and second circumferential grooves 63 and 65. This is accomplished in a known manner via sealing action of a pair of sealing rings 84 of rectangular cross section disposed in circumferential grooves 86 formed between the relief circumferential groove 80 and the first and second circumferential grooves 63 and 65. The O-ring used in conjunction with the straight thread “O” ring boss 42 serves to fluidly retain pressurized fluid in the first circumferential groove while another O-ring used in conjunction with another “O” ring boss 88 is utilized to fluidly retain pressurized fluid in the second circumferential groove. In addition, a nut 90 and washer 92 included in the “O” ring boss 88 provide a locking function for securing the valve body 40 fixedly in place within manifold block 44.

Preferably, the first and second solenoids 36 and 38 are formed with removable coils 94 and fluidly sealed tubes 96 that are similarly adapted for positioning and retention within straight thread “O” ring bosses 98 formed within either end of the valve body 40. As such, fluid is retained within the valve body 40 by O-rings used in conjunction with the straight thread “O” ring bosses 98. In addition, internal portions of each fluidly sealed tube 96 are vented to the same fluid pressure present at the contact node 54 and shoulders 61 via passageways 100 formed in each of the first and second valve spools 46 and 48.

With reference now again to FIG. 3, the system controller 16 issues motor controlling signals to the motor in dependence upon at least an applied torque signal indicative of steering torque applied to steering wheel 11 as generated by at least one of the redundant torque sensors 28 and 28′ in order to control the power steering system 10C. Preferably, the power steering system 10C also includes respective first and second pressure transducers 64A and 64B for issuing pressure signals to the system controller 16 that are representative of instant pressure values present in the first and second fluid lines 18 and 20. In that case, the system controller 16 establishes closed-loop control of differential fluid pressure delivered by the pump 14 to the first and second ports 56 and 58 of the power cylinder 12 while also directing the solenoid-controlled valve apparatus 130 to fluidly couple the one of the first and second ports 56 and 58 of the power cylinder 12 having lower pressure to the system reservoir 22.

Curve 108 in FIG. 5 is a typical “pressure-effort” curve depicting operation of the power steering system 10C wherein “on-center,” or zero applied steering torque operation is implemented with zero differential pressure applied to the power cylinder 12 as depicted at point 110. Such operation is typical under conditions of no cross wind or appreciable road crown. On the other hand, the power steering system 10C is also capable of operating with zero applied steering torque under conditions of significant cross wind or appreciable road crown. This is accomplished via the system controller 16 internally processing a pressure offset signal to generate an atypical “pressure-effort” curve 112 having an offset or non-zero valued differential pressure on-center as depicted at point 114. In so doing a driver of the host vehicle will not sense steering forces supplied by the power steering system 10C in opposition to the presence of a continuing cross wind or appreciable road crown. The system controller 16 may gradually initiate the offset based upon a sensed fairly constant, small torque from the torque sensor 28 that exceed a predetermined period of time.

The problem that such offset operation presents, however, is that the associated transfer of polarity of differential pressure between the first fluid line 18 and the second fluid line 20 occurs off-center at point 116 whereat the curve 112 has a non-zero slope, and further, whereat the driver is probably moving the steering wheel 11. In order to ensure a smooth transfer of one of the first fluid line 18 and the second fluid line 20 being fluidly connected to the system reservoir 22 to the other, it is preferable to form the first and second valve body ports 66 and 68, and the shoulders 61 of the first and second valve spools 46 and 48 such that their metering edges 118 and 120 are spaced in a critically lapped fashion whenever the first and second valve spools 46 and 48 are abutted at contact node 54. This ensures simultaneous fluid decoupling and coupling of the first and second, or second and first, fluid lines 18 and 20 with the system reservoir 22 as either of the first and second solenoids 36 or 38 is de-energized and the opposing solenoid 38 or 36 energized.

First and second check valves 122 and 124 depicted in FIG. 3 are utilized for fluidly coupling the system reservoir 22 to a first or second pump port 226 or 228 whenever either is sufficiently subject to a suction condition. Such suction conditions are induced in either of the first or second pump ports 226 or 228 whenever the pump 14 is operated above a selected speed. This condition is implemented is implemented via pressure drop at either of orifices 230 placed in the first fluid line 18 and the second fluid line 20 between the first and second check valves 122 and 124 and the solenoid-controlled valve apparatus 130. When operated in this manner, some of the returning (i.e., from the port 56 or 58 of the power cylinder 12 having lower pressure) fluid is then returned to the system reservoir 22 via the respective one of the back-to-back solenoid-controlled two-way valves 126 or 128 even as a like flow of fresh replenishment fluid is then supplied to the respective first or second pump port 226 or 228 via the respective one of the first and second check valves 122 and 124.

Having described the invention, however, many modifications thereto will become immediately apparent to those skilled in the art to which it pertains, without deviation from the spirit of the invention. In one example, the solenoid-controlled two-way valves 126 or 128 are separated from one another instead of locating them in their preferred back-to-back orientation in the common valve bore 50. And of course, the valve body 40 could additionally include first and second internal grooves in communication with the first and second valve body ports 66 and 68 with appropriate edges thereof interdicting with the shoulders 61 in place of the first and second valve body ports 66 and 68 themselves. Such modifications clearly fall within the scope of the invention. Also, in the examples shown, the driver input is via a steering wheel 11 and the signal from the sensor represents torque; however, other driver inputs, input signals and input devices could also be used.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of operating a hydro-mechanically coupled power steering system having a pump coupled to a power cylinder, the method comprising the steps of:
a) sensing a steering input from a driver;
b) at least substantially de-coupling the pump from the power cylinder based upon the sensed steering input decreasing below a first threshold value; and
c) coupling the pump to the power cylinder based upon the sensed steering input increasing above a second threshold value.

2. The method of claim 1 wherein said step c) further includes the step of progressively coupling the pump to the power cylinder as the sensed steering input increases.

3. The method of claim 1 wherein said step b) further includes the step of coupling at least one of the pump and the power cylinder to a system reservoir based upon the sensed steering input decreasing below the first threshold value.

4. The method of claim 1 wherein said step b) further includes the step of coupling an input of the pump to an output of the pump.

5. The method of claim 1 wherein the steering input from the driver is a steering wheel input.

6. The method of claim 1 wherein the sensed steering input from the driver is a torque and wherein the torque is compared to the first threshold value in said step b) and to the second threshold value in said step c).

7. The method of claim 1 wherein the first threshold value is equal to the second threshold value.

8. The method of claim 1 wherein the power steering system further includes first and second fluid lines coupling the pump to the power cylinder.

9. The method of claim 8 wherein said step b) further includes the step of coupling the first line to the second line.

10. The method of claim 8 wherein said step b) further includes the step of coupling at least one of the first and second fluid lines to a system fluid reservoir.

11. A power steering system comprising:
at least one pump;
at least one power cylinder; and
at least one valve selectively effectively coupling and decoupling the at least one power cylinder from the at least one pump.

12. The system of claim 11 further including fluid lines connecting the at least one pump to the at least one power cylinder.

13. The system of claim 12 wherein the at least one valve selectively couples the fluid lines to one another in order to selectively decouple the at least one power cylinder from the at least one pump.

14. The system of claim 12 wherein the at least one valve selectively couples the fluid lines to a system fluid reservoir in order to selectively decouple the at least one power cylinder from the at least one pump.

15. The system of claim 11 further including a driver input sensor, the at least one valve selectively coupling and decoupling the at least one power cylinder to the at least one pump based upon a signal from the driver input sensor.

16. The system of claim 15 wherein the driver input sensor is a torque sensor.

17. The system of claim 16 wherein the at least one valve includes a proportionally-controlled spring-loaded compound two-way valve.

18. The system of claim 16 wherein the at least one valve includes at least one solenoid.

19. The system of claim 16 wherein the at least one valve includes first and second solenoid-controlled two-way valves.

20. The system of claim 11 further including a vehicle sensor, the at least one valve selectively coupling or decoupling the at least one power cylinder to the at least one pump based upon a signal from the vehicle sensor.

21. The system of claim 20 further including a driver input sensor, the at least one valve selectively coupling and decoupling the at least one power cylinder to the at least one pump based upon the signal from the vehicle sensor and based upon a signal from the driver input sensor.

22. The system of claim 21 wherein the vehicle sensor is a vehicle speed sensor.

23. The system of claim 22 wherein the at least one valve progressively couples the at least one power cylinder to the at least one pump based upon at least one of the signal from the driver input sensor and the signal from the vehicle speed sensor.

24. The system of claim 21 wherein the driver input sensor is a torque sensor.

25. The system of claim 11 wherein the at least one valve includes at least one solenoid.

26. The system of claim 11 wherein the at least one valve includes first and second solenoid-controlled two-way valves.

27. A hydraulically coupled power steering system comprising:
a pump;
a power cylinder;
a first fluid line coupling the pump to a first port of the power cylinder;
a second fluid line coupling the pump to a second port of the power cylinder;
a system reservoir; and
a valve assembly including first and second solenoid-controlled two-way valves for selectively fluidly coupling the first fluid line and the second fluid line to the system reservoir.

28. The system of claim 27 further including:
at least one driver input sensor for generating a driver input signal in response to a driver input; and
a system controller selectively actuating the first and second solenoid-controlled two-way valves based upon the driver input signal.

29. The system of claim 28 wherein the at least one driver input sensor includes at least one torque sensor measuring an applied torque to a steering wheel and generating an applied torque signal.

30. The system of claim 29 wherein the system controller selectively controls fluid pressure to one of the first port and the second port of the power cylinder based upon the applied torque signal while controlling the valve assembly to couple the other of the first port and the second port of the power cylinder to the reservoir.

31. The system of claim 30 wherein the first and second solenoid-controlled two-way valves includes first and second valve spools disposed back-to-back within a common bore formed in a valve body.

32. The system of claim 31 wherein the first and second valve spools having metering edges, the valve body having metering edges, wherein the metering edges of the first and second valve spools are spaced in a critically lapped fashion with reference to the metering edges of the valve body such that when either of the first and second solenoids is energized while the other is de-energized, the energized solenoid simultaneously urges both of the first and second valve spools toward a position in which one of the first and second fluid lines is decoupled from the system reservoir and the other of the first and second fluid lines is coupled to the system reservoir.

33. The system of claim 32 wherein the first and second valve spools are urged apart by a spring such that both of the first and second fluid lines are coupled to the reservoir when both of the first and second solenoids are de-energized.

34. The system of claim 27 further comprising first and second pressure transducers generating pressure signals representative of pressure in the first and second fluid lines, respectively, the controller establishing closed-loop control of differential fluid pressure delivered by the pump to the first and second ports of the power cylinder and directing the valve assembly to fluidly couple a lower-pressure one of the first and second ports of the power cylinder to the system reservoir.

35. The system of claim 27 further comprising a first check valve for fluidly coupling the system reservoir to a first pump port based upon the first pump port having a suction condition in excess of a first threshold.

36. The system of claim 35 wherein the first fluid line is connected to the first pump port, the system further including a first orifice in the first line between the first check valve and the valve assembly.

37. The system of claim 36 wherein fluid is supplied to the first pump port via the first check valve based upon the pump being operated above a threshold rate and based upon the first pump port having the suction condition in excess of the first threshold,

38. A valve assembly comprising:
a valve body having a bore therein; a first port, a second port and a relief port extending through the body to the bore;
a first valve spool having a metering edge, the first valve spool disposed within the bore for selectively fluidly coupling the first port to the relief port;
a second valve spool having a metering edge, the second valve spool disposed within the bore for selectively fluidly coupling the second port to the relief port;
a first solenoid operatively coupled to the first valve spool;
a second solenoid operatively coupled to the second valve spool; and
the valve body having metering edges, wherein the metering edges of the first valve spool and the second valve spool are spaced in a lapped fashion with reference to the metering edges of the valve body such that when either of the first solenoid or the second solenoid is energized while the other is de-energized, the energized one of the first solenoid and the second solenoid urges both the first valve spool and the second valve spool toward a position in which one of the first port and the second port is decoupled from the relief port and the other of the first port and the second port is coupled to the relief port.

39. The valve assembly of claim 38 further including a spring urging the first valve spool and the second valve spool away from one another such that both of the first port and the second port are coupled to the relief port whenever both of the first solenoid and the second solenoid are de-energized.

40. The valve assembly of claim 38 wherein the first valve spool and the second valve spool are positioned between the first solenoid and the second solenoid.
